(19) United States
(12) Patent Application Publication
(10) Pub. No.: US 2021/0103253 A1
(43) Pub. Date: Apr. 8, 2021

(54) INTEGRATED TIME RECORDER AND USER TEMPERATURE SENSOR

(71) Applicant: Michael Symolon, Farmington, CT (US)

(72) Inventor: Michael Symolon, Farmington, CT (US)

(21) Appl. No.: 17/065,182

(22) Filed: Oct. 7, 2020

Related U.S. Application Data
(60) Provisional application No. 62/911,466, filed on Oct. 7, 2019.

(51) Int. Cl. G04G 21/02; G01K 13/00; G01K 3/00; G04F 10/00; G04G 21/04; G04G 19/00; G07C 1/10

(52) U.S. Cl. CPC G04G 21/025; G01K 13/002; G01K 3/005; G07C 1/10; G04G 21/04; G04G 19/00; G04F 10/00

(57) ABSTRACT

According to some embodiments, a time recorder is disclosed. The time recorder comprises one or more biometric sensors to determine a user accessing the time recorder. The time recorder further comprises an electronic clock to determine a time that the user accessed the time recorder and a network transmitter to synchronize the time recorder with one or more of a plurality of time recorders. Input of biometrics of a new user at the time recorder may be populated across one or more of the plurality of time recorders via the network transmitter.

### BACKGROUND

A time recorder is conventionally used to record start and end times for employees (e.g., hourly employees). Time recorders were originally mechanical based and functioned by inserting time cards into a slot on the time recorder. When the time card was inserted into the time recorder, the time recorder would print day and time information (e.g., a timestamp) on the time card. In more modern system, the time recorder uploads the timestamp to a centralized system and may use a Radio-frequency identification (“RFID”) to automatically identify an employee. Conventional systems, as disclosed above, are widely used for permanent installations where power and hardwiring are available to connect devices to a centralized system. However, these conventional systems are not practical for use in remote or temporary worksites (e.g., festivals, concerts, construction sites, etc.). It would therefore be desirable to provide a time recording system that is practical for remote or temporary worksites as well as for use in traditional settings.

### SUMMARY

Some embodiments described herein relate to a time recorder. The time recorder comprises one or more biometric sensors to determine a user accessing the time recorder. The time recorder further comprises an electronic clock to determine a time that the user accessed the time recorder and a network transmitter to synchronize the time recorder with one or more of a plurality of time recorders. Input of biometrics of a new user at the time recorder may be populated across one or more of plurality of time recorders via the network transmitter.

### BRIEF DESCRIPTION OF THE DRAWINGS

FIG. 1 illustrates a remote worksite according to some embodiments.

FIG. 2 illustrates a system according to some embodiments.

FIG. 3 illustrates a time recorder according to some embodiments.

FIG. 4 illustrates a method according to some embodiments.

### DETAILED DESCRIPTION

In the following detailed description, numerous specific details are set forth in order to provide a thorough understanding of the embodiments. However, it will be understood by those of ordinary skill in the art that the embodiments may be practiced without these specific details. In other instances, well-known methods, procedures, components and circuits have not been described in detail so as not to obscure the embodiments.

In some embodiments, the present embodiments relate to a time recorder with a built-in temperature sensor that may be used to (i) monitor a temperature of a worker before the worker enters a worksite and (ii) monitor a temperature of the worker when he leaves the worksite. As such, the time recorder can prevent an infected person from entering a worksite as well as determine if the person showed signs of being infected while at the worksite in order to slow the spread of any contagion.

The present embodiments relate to a time recorder that includes an internal power supply and is designed to be used in locations that may not be accessible to wired or Wi-Fi networks or may be used in environments where making such connections are inconvenient. The time recorder described herein may be used for organizations that may need to track employee, contractors, volunteers, members, guests or agents time duration at specific locations. The time recorder may also be used for individuals who have to verify they visited various locations, remote temporary locations (e.g., construction sites, security companies, concerts or festivals), or health care providers that visit with a variety of remote patients. The time recorder may utilize an external power supply or power over the ethernet (PoE) in some embodiments.

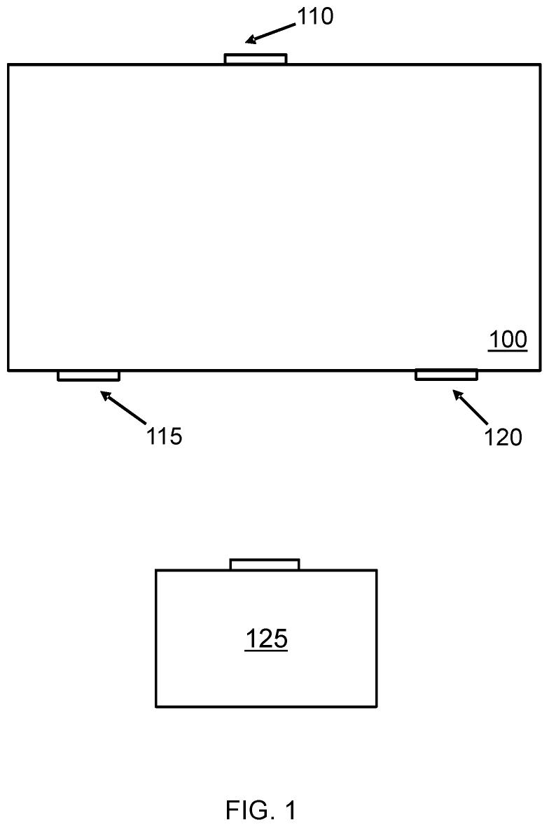

Referring now to FIG. 1, an embodiment of a remote worksite 100 is illustrated. For purposes of illustrating features of the present embodiments, a simple example will now be introduced and referenced throughout the disclosure. Those skilled in the art will recognize that this example is illustrative and is not limiting and is provided purely for explanatory purposes. In some embodiments, the worksite 100 is for the construction of a new building and the worksite 100 has three entrances each using a time machine as described herein to control access to the worksite (e.g., unlocks a door or gate or indicates to a guard that a user can enter). For example, a first time recorder 110 may be position by a first entrance, a second time recorder 115 may be position by a second entrance and a third time recorder 120 may be position by the third entrance. A user (e.g., a worker) who wants to gain access to the worksite 100 via the first entrance may need to be authenticated via the first time recorder 110. Authentication may occur based on the time recorder 110 detecting an RFID chip carried by the user and receiving a unique ID code from the RFID chip, keying in an ID number, or identifying an individual via one or more bio-metric scans such as, but not limited to a scanning a fingerprint using a fingerprint sensor, scanning a retina via a retina scanner, scanning a face via a facial scanner, scanning the presence of a person using an energetic presence scanner that scans the user's body shape and size or other unique features associated with the person, scanning a temperature using a body temperature sensor and scanning contents of the user's breath using a breath sensor.

If the user's breath is analyzed and is found to contain alcohol or other notable substances, the user may be denied access to the worksite 100 and if the user's temperature if above a preset temperature (e.g., 99 degrees Fahrenheit) the user may also be denied access. The first time recorder 110 may also scan other biometric aspects of the user to determine if the user has permission to enter the worksite 100.

One advantage over conventional systems is that the time recorders disclosed herein may be in communication with other time recorders associated with the same worksite 100. In some embodiments, the time recorders may communicate with the other time recorders using cellular networks via a subscriber identification module (SIM) card. For example, the first time recorder 110, after determining that a user's temperature is above a preset temperature, or that the user's breath contains alcohol, may transmit to the second time recorder 115 and the third time recorder 120 that the user's access has been revoked. This may prevent a user from entering a worksite at a different entrance, or even in different locations of great distance. Similarly, once a user has gained access to the worksite, the first time recorder 110 may transmit to the second time recorder 115 and the third time recorder 120 that the user is now located on the worksite. The first time recorder 110 may also transmit to a time recorder located at a remote location. For example, warehouse 125 may be a great distance from the worksite 100. However, once the user is authenticated for the worksite 100, the user may also be authenticated to access the warehouse 125. In this way, the user may enter or leave the worksite 100 via any entrance and their presence, or lack of presence, is known by each time recorder. The time recorders may communicate with each other as part of a peer-to-peer network, communicate with a remote database, or may simply function using a store and forward technique to send data to a next time recorder. Each time recorder 110/115/120 may transmit a signal to a locking mechanism (not shown) to indicate that a user has been authenticated and to indicate to the locking mechanism to release a lock. If the user's temperature is greater than a predetermined temperature or a breath sensor indicates a notable substance, the signal may not be transmitted to the locking mechanism to release the lock.

Besides being able to scan/record a user attempting to enter (or exit) the worksite 100, the time recorder may also store identification information, or may be able to retrieve the identification information via the SIM or network connection from a secure remote database for validation. Likewise, validation information can be uploaded to each of the time recorders as needed. Information transmitted from the first time recorder 110 to the second time recorder 115 as well as information received from a global positioning system (GPS) such as coordinates may be stored in a local database at each individual time recorder for further analysis or processing, or electronically acted upon immediately.

Each time recorder may use GPS and/or information transmitted over a cellular or other network for determining a time zone. Each time recorder 110/115/120 may comprise a programmable tolerance range (based on GPS coordinates) in case the apparatus is moved at a same work site/venue/functional location (e.g., moved 20 ft from its original location). For example, if the first time recorder 110 is moved 5 or 10 feet from its indicated location, the first time recorder 110 may not be considered tampered with or moved because worksites typically require frequent reconfiguration (e.g., a wider door opening is needed, a pole supporting the time recorder broke, etc.). Besides communicating locally at a worksite via a network (e.g., a cellular network) each time recorder 110/115/120 may function as part of a time recorder system.

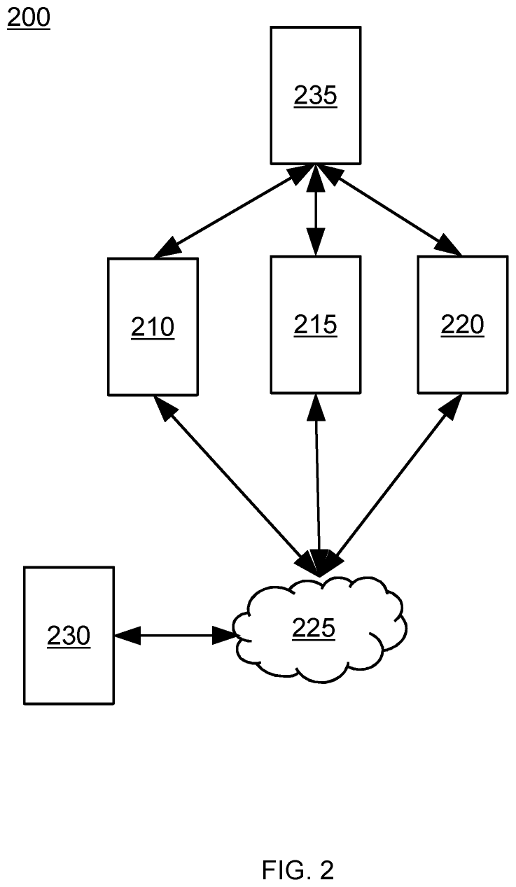

Now referring to FIG. 2, an embodiment of a time recorder system 200 is disclosed. The system comprises a plurality of time recorders 210/215/220 such as the time recorders 110/115/120 described with respect to FIG. 1. The plurality of time recorders 210/215/220 may be communicatively connected to a back-end system 230 via a network 225. In some embodiments, the network 225 may comprise a cellular network. In some embodiments, the network 225 may comprise, but is not limited to, one or more of a cellular network, a wired network, an IEEE 802.11 based network (e.g., Wi-Fi), and/or a “short-link” radio technology (e.g., BLUETOOTH).

The back-end system 230 may comprise a remote database and a web-based interface to allow control and monitoring and updating of the plurality of time recorders 210/215/220 from a remote location. The back-end system 230 may provide access and control of the plurality of time recorders 210/215/220 so that a manager can remotely enter user information that is then populated across each of the plurality of time recorders 210/215/220. The back-end system 230 may also backup local data stored at each of the plurality of time recorders 210/215/220 or provide a centralized database associated with user/biometric information that may be selectively accessible to the plurality of time recorders 210/215/220.

Continuing with the example of FIG. 1, if a new worker (e.g., temporary worker, day worker, a new hire) arrives at the worksite prior to their information being entered into the back-end system 230 (i.e., the new worker does not have access), information associated with the new user may be entered directly into one of the plurality of time recorders 210/215/220. For example, each of the plurality of time recorders 210/215/220 comprises one or more input devices (e.g., a keypad, a microphone, a camera, one or more biometric sensors such as, but not limited to, a fingerprint sensor, a retina scanner, a facial scanner, voice scanner, energetic presence scanner, a body temperature sensor and a breath sensor). The new user may enter his information, including biometric data, into one of the plurality of time recorders 210/215/220 while onsite at the worksite. The one of the plurality of time recorders 210/215/220 may then forward the information associated with the new work to each of the plurality of time recorders 210/215/220 and/or to the back-end system 230. This allows the new user to gain quicker access to the worksite by having direct entry into each of the plurality of time recorders 210/215/220, or even other associated locations elsewhere. Since each of the plurality of time recorders 210/215/220 communicates to each other view in a peer-to-peer manner and/or a store and forward manner, in some embodiments where it is not practical to use a back-end system, the plurality of time recorders 210/215/220 may function as their own independent system without the back-end system 230. In some embodiments, if one of the plurality of time recorders 210/215/220 determines that a user leaves early, based on stored user information (either locally stored on at the back-end system) and/or biometric data, an alert may be transmitted via the network 225 to a supervisor directly or to a machine used for reporting to the supervisor.

Each of the plurality of time recorders 210/215/220 may also be in communication with a global positioning satellite (GPS) system 235. Communication with a GPS system 235 may facilitate the verification of a location of each time recorder to prevent tampering of the time recorder (e.g., being moved away from its current location and then returned) and/or to identify a current location of the time recorder. In some embodiments, a local time at the time recorder is verified by GPS to prevent tampering and/or as a way of determining a time zone of the time recorder (to aid in location tracking). In some embodiments, each of the plurality of time recorders 210/215/220 may transmit its stored GPS coordinates to the GPS system 235 to verify a current location and may also receive GPS coordinates from the GPS system.

In some embodiments the back-end system 230 comprises a server and a database. In some embodiments, when each of plurality of time recorders 210/215/220 is powered up, each of the plurality of time recorders 210/215/220 may automatically connect to an application running on the back-end system 230 based on pre-programmed connection information that is stored in each of the plurality of time recorders 210/215/220. For example, each of the plurality of time recorders 210/215/220 may comprise a configuration file that indicates a type of network, a network address and authentication information. Thus, when each plurality of time recorders 210/215/220 is powered up, a connection determined by the configuration file is established. In some embodiments, the configuration information may be hard coded into nonvolatile memory in the device or SIM card. In some embodiments, the back-end system 230 may download configuration information and time synchronization information to one or more of the plurality of time recorders 210/215/220. For example, if a time recorder is stolen, a new time recorder may be installed an all user information, bio-metric information, and time related information may be restored to the new time recorder via the back-end system.

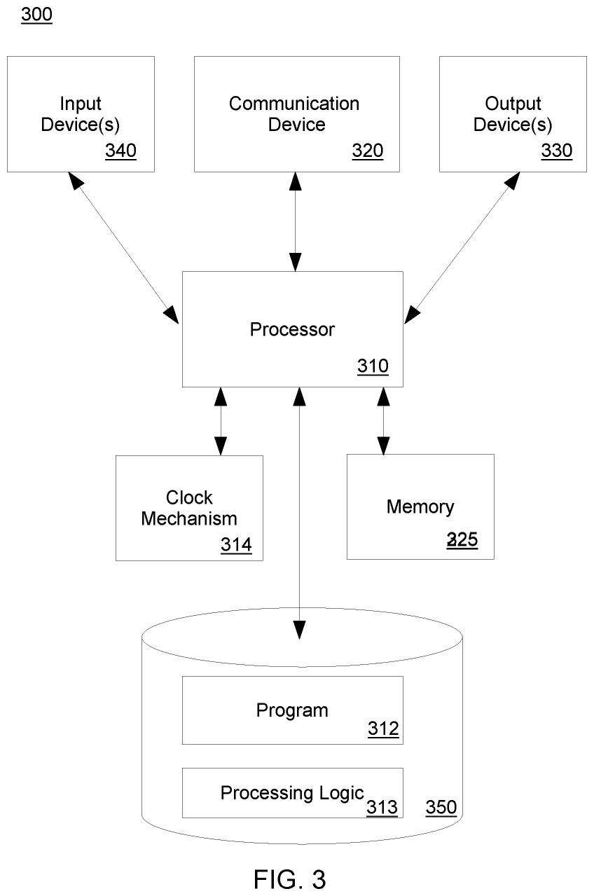

Note the embodiments described herein may be implemented using any number of different hardware configurations. For example, FIG. 3 illustrates a time recorder 300 that may be, for example, associated with the time recorders disclosed in FIG. 1 and FIG. 2. The time recorder 300 may provide a technical and commercial advantage by being able to provide direct entry of both user information and biometric information at the time recorder and to broadcast the input information to other time recorders with or without the use of a centralized system.

The time recorder 300 may comprise a processor 310 (“processor”), such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more machines on a network. In some embodiments, the communication device 320 may comprise a network transmitter that may be selectable as a cellular transmitter, a Wi-Fi transmitter, a BLUETOOTH transmitter, or a wired network transmitter. In some embodiments, multiple communication devices 320 may be present such that the time recorder 300 comprises one or more of a cellular transmitter, a Wi-Fi transmitter, a BLUETOOTH transmitter, and a wired network connection. The time recorder 300 further includes an input device 340 (e.g., touch screen, touch pad and/or electronic keyboard to enter information about a user and/or one or more biometric sensors) and an output device 330 (e.g., to output and display data and/or alerts) such as a display screen.

The processor 310 also communicates with a memory 325 and storage device 350 that stores data 313. The storage device 350 may comprise any appropriate information storage device, including combinations of magnetic storage devices (e.g., a hard disk drive), optical storage devices, mobile telephones, and/or nonvolatile semiconductor memory devices. The storage device 350 may store a program 312 and/or processing logic 313 for controlling the processor 310. The processor 310 performs instructions of the programs 312, 313, and thereby operates in accordance with any of the embodiments described herein. For example, the processor 310 may receive information associated with a new user and may transmit that information to other time recorders via the instructions of the programs 312 and processing logic 313.

The programs 312, 313 may be stored in a compiled, compressed, uncompiled and/or encrypted format or a combination. The programs 312, 313 may furthermore include other program elements, such as an operating system, a database management system, and/or device drivers used by the processor 310 to interface with peripheral devices.

The clock mechanism 314 may be used to coordinate times associated with a user accessing the time recorder as well as synchronizing an internal clock time with a GPS system or with other time recorders. In some embodiments, the clock mechanism 314 may be internal to the processor 310. The clock mechanism 314 may comprise an electronic clock.

As will be appreciated by one skilled in the art, some or all of the present embodiments may be embodied as a system, method or computer program product. Accordingly, the embodiments described herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the embodiments described herein may take the form of a computer program product embodied in one or more computer readable medium(s) having computer readable program code embodied thereon.

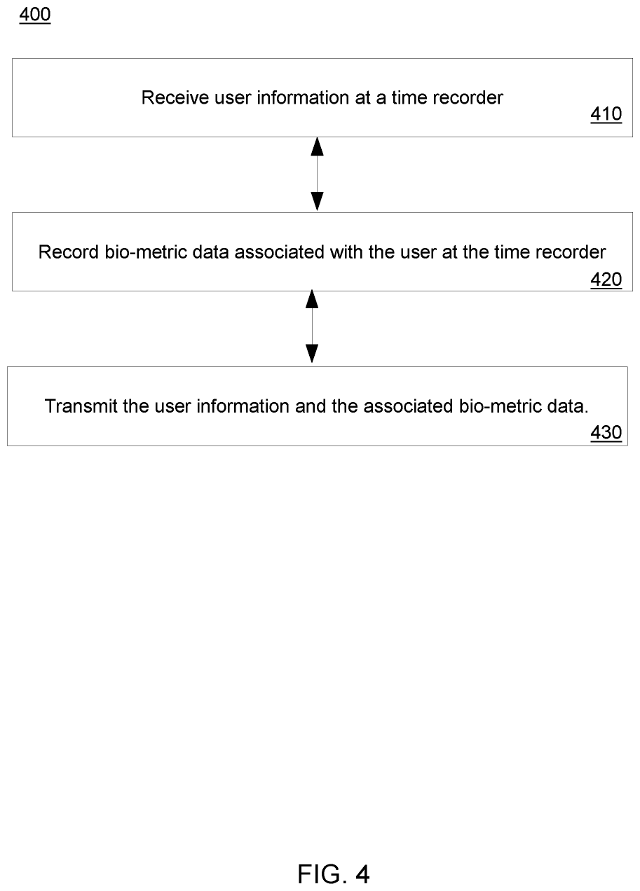

Now referring to FIG. 4, a method 200 that might be performed by a time recorder, such as the first device 110, described with respect to FIG. 1, is illustrated according to some embodiments. The method described herein does not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

Method 400 may relate to implementing direct entry of both user information and biometric information at a local time recorder and broadcasting the user information and biometric information to other time recorders without the use of a centralized system. Now referring to 410, user information may be received at a time recorder. The user information may comprise one or more of a user's name, address, height, weight, bio-metric data, identification number, password, times that the user is allowed on the worksite, security level, etc. The user information may be entered locally at the time recorder or may be received over a network from a back-end system 230.

The user may record his/her bio-metric data directly into the time recorder, at 420, using one or more biometric sensors such as, but not limited to, a fingerprint sensor, a retina scanner, a facial scanner, scanner, an energetic presence scanner, a body temperature sensor and a breath sensor.

Once the user information and the biometric information have been entered into the time recorder, at 430, the user information and the associated bio-metric data may be transmitted to one or more other time recorders and/or the back-end system such as back-end system 230.

The process flow and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

This written description uses examples to disclose multiple embodiments, including the preferred embodiments, and also to enable any person skilled in the art to practice the invention, including making and using any devices or systems and performing any incorporated methods. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed:

1. A time recorder comprising:
one or more biometric sensors to determine a user accessing the time recorder;
an electronic clock to determine a time that the user accessed the time recorder; and
a network transmitter to synchronize the time recorder with one or more of a plurality of time recorders, wherein input of biometrics of a new user at the time recorder is populated across the plurality of time recorders via the network transmitter.

2. The time recorder of claim 1, wherein the network transmitter is a cellular transmitter via a SIM card.

3. The time recorder of claim 1, wherein the network transmitter is selectable to be a cellular transmitter, a Wi-Fi transmitter, a BLUETOOTH transmitter, or a wired network transmitter.

4. The time recorder of claim 1, wherein the one or more biometric sensors comprise at least one of a fingerprint sensor, a retina scanner, a facial scanner, scanner, energetic presence scanner, a body temperature sensor and a breath sensor.

5. The time recorder of claim 1, wherein the time recorder is powered by power over the ethernet (PoE).

6. The time recorder of claim 5, wherein if the user is determined to leave early, based on the stored user and biometric data, an alert will be transmitted to a supervisor or external database for reporting to a supervisor.

7. The time recorder of claim 1, wherein a location of the time recorder is verified by GPS to prevent tampering and/or to identify a location of the time recorder.

8. The time recorder of claim 1, wherein a local time at the time recorder is verified by GPS to prevent tampering and/or to identify a location of the time recorder.

9. The time recorder of claim 4, wherein the user will be denied access if the body temperature sensor determines a temperature above a preset temperature.

10. A time recorder system comprising:
a plurality of time recorders wherein each time recorder of the plurality of time recorders comprises one or more biometric sensors to determine a user accessing the time recorder, an electronic clock to determine a time that the user accessed the time recorder, a storage medium to store user and biometric data, and a network transmitter to synchronize each time recorder in the a plurality of time recorders, wherein input of biometrics of a new user at one of the plurality of time recorder is populated across the plurality of time recorders via the network transmitter and wherein the one or more biometric sensors comprise at least one of a fingerprint sensor, a retina scanner, a facial scanner, scanner, energetic presence scanner, a body temperature sensor and a breath sensor.

11. The time recorder system of claim 10, wherein each network transmitter is a cellular transmitter via a SIM card.

12. The time recorder system of claim 10, wherein each network transmitter is selectable to be a cellular transmitter, a Wi-Fi transmitter, a BLUETOOTH transmitter, or a wired network transmitter.

13. The time recorder system of claim 10, wherein the plurality of time recorders functions as a peer-to-peer network.

14. The time recorder system of claim 10, wherein the plurality of time recorders functions in a store and forward manner.

15. The time recorder system of claim 10, wherein the network transmitter synchronizes each time recorder in the plurality of time recorders and synchronizes with a remote database associated with a back-end system.

16. The time recorder system of claim 10, wherein the user will be denied access if the body temperature sensor determines a temperature above a preset temperature, and the user's temperature will be transmitted to each of plurality of time recorders to prevent access at other time recorders.

17. A time recorder system comprising:
a plurality of time recorders wherein each time recorder of the plurality of peer-to-peer time recorders comprises one or more biometric sensors to determine a user accessing the time recorder, a clock mechanism to determine a time that the user accessed the time recorder, a storage medium to store user and biometric data, and a network transmitter to synchronize each time recorder in the a plurality of time recorders, wherein input of biometrics of a new user at one of the plurality of time recorder is populated across the plurality of time recorders via the network transmitter; and
a back-end system in communication with the plurality of time recorders.

18. The time recorder system of claim 17, wherein the back-end system provides web access to the plurality of time recorders.

19. The time recorder system of claim 17, wherein powering up a first of the plurality of time recorders causes the first of the plurality of time recorders to automatically connect to an application running on the back-end system based on pre-programmed connection information.

20. The time recorder system of claim 17, wherein the back-end system downloads configuration information and time synchronization information to one or more of the plurality of time recorders.
